(19) United States
(12) Patent Application Publication
(10) Pub. No.: US 2026/0287464 A1
(43) Pub. Date: Sep. 24, 2026

(54) FREE-VIBRATION TESTING DEVICE FOR SIMULATING NONLINEAR STIFFNESS OF BRIDGE RIGID MODEL

(71) Applicant: DALIAN UNIVERSITY OF TECHNOLOGY, Dalian (CN)

(72) Inventors: Fuyou XU, Dalian (CN); Pinqing WANG, Dalian (CN); Yan HAN, Dalian (CN); Mingjie ZHANG, Dalian (CN); Rui ZHOU, Dalian (CN); Xiaobo WU, Dalian (CN); Lin CHEN, Dalian (CN); Zhanbiao ZHANG, Dalian (CN)

(21) Appl. No.: 19/684,678

(22) Filed: May 21, 2026

(30) Foreign Application Priority Data
Aug. 13, 2025 (CN) 202511127516.7

(51) Int. Cl. G01M 9/04; G01M 7/02

(52) U.S. Cl. CPC G01M 9/04; G01M 7/027

(57) ABSTRACT

The present invention belongs to the technical field of bridge wind tunnel test devices, and provides a free-vibration testing device for simulating nonlinear stiffness of a bridge rigid model. By flexibly designing the shape and the size of the rigid arc-shaped supporting arms, the spatial positions of the fixed bearing pulleys, the initial strains of the springs, and other parameters, this device can achieve multiple vertical-torsional coupled nonlinear stiffness modes, and also can achieve nonlinear stiffness only in the vertical direction while maintaining constant torsional stiffness, so as to carry out large-amplitude vertical-torsional coupled flutter and large-amplitude vertical galloping measurement tests under the nonlinear stiffness of bridge structures. During the large-amplitude vibration process of the model, the springs can always remain in a vertical state and will not experience lateral vibration, ensuring that the testing device has stable low damping, mass, and stiffness.

### TECHNICAL FIELD

The present invention belongs to the technical field of bridge wind tunnel test devices, and relates to a free-vibration testing device for simulating nonlinear stiffness of a bridge rigid model.

### BACKGROUND

Long-span bridges have flexible structures and low damping, and are prone to large-amplitude wind-induced vibrations such as flutter and galloping. In the process of large-amplitude wind-induced vibrations, a dual nonlinear effect of the coupling of nonlinear structural stiffness and nonlinear aerodynamic force exists. However, the existing research and fortification concepts of large-amplitude wind-induced vibrations are mainly based on the assumption of linear structures, which has hindered the accurate simulation of the nonlinear behavior of structural stiffness in large-amplitude vibrations. The free-vibration wind tunnel test of the bridge deck rigid sectional model is an important means to study the wind resistance performance of long-span bridges. However, the existing wind tunnel test research of large-amplitude flutter of the bridge deck rigid sectional model is all based on the assumption that the testing device stiffness remains constant. The authorized Chinese patent (a vertical-torsional coupled large-amplitude free-vibration wind tunnel test device of a bridge CN108414186B, corresponding to U.S. Pat. No. 10,866,159 B2) of the applicant converts the torsional displacement of a rigid model into the stretching and contracting deformation of vertical springs by using a circular hub, which can maintain very ideal constant stiffness under vertical-torsional coupled large-amplitude free vibrations, so as to study the nonlinear aerodynamic effects. However, the test condition where both vertical stiffness and torsional stiffness are nonlinear cannot be considered in this device. In addition, few research reports are given on nonlinear stiffness test devices for vertical large-amplitude galloping at present. Therefore, it is urgent to develop a large-amplitude and stable low-damping free-vibration wind tunnel test device that can achieve nonlinear stiffness in both vertical and torsional directions and nonlinear stiffness only in the vertical direction.

### SUMMARY

A technical problem to be solved in the present invention is to further modify the authorized Chinese patent (a vertical-torsional coupled large-amplitude free-vibration wind tunnel test device of a bridge CN108414186B, corresponding to U.S. Pat. No. 10,866,159 B2) of the applicant in response to the need for large-amplitude free-vibration wind tunnel tests of rigid sectional models of bridge decks and other components under nonlinear stiffness, so as to simulate nonlinear stiffness in both vertical and torsional directions and nonlinear stiffness only in the vertical direction while maintaining constant torsional stiffness, and always keep the springs vertical under different amplitudes to achieve stable low damping. The device comprises a rigid model, rigid rods, rigid arc-shaped supporting arms, fixed bearing pulleys, linear tensile springs, and lightweight high-strength thin strings.

The technical solution of the present invention is as follows:

A free-vibration testing device for simulating nonlinear stiffness of a bridge rigid model comprises a rigid model 1, rigid rods 2, rigid arc-shaped supporting arms 3, first fixed bearing pulleys 4, first linear tensile springs 5, first lightweight high-strength thin strings 6, second fixed bearing pulleys 7, second linear tensile springs 8, and second lightweight high-strength thin strings 9; the rigid rods 2 are fixed at both ends of the rigid model 1, the torsion center line of the rigid model 1 is ensured to be collinear with the axes of the rigid rods 2, and the free ends of the rigid rods 2 pass perpendicularly through and are fixed to the center of the rigid arc-shaped supporting arms 3; the rigid arc-shaped supporting arm 3 is of a symmetrical structure and is mainly composed of arc-shaped rods connected to both ends of a straight rod, and the outer wall surfaces of the arc-shaped rods are provided with grooves; two first fixed bearing pulleys 4, two first linear tensile springs 5, and two first lightweight high-strength thin strings 6 are provided at each upper side of the rigid model 1 and arranged in a symmetrical structure, and the first fixed bearing pulleys 4 are ensured to be directly below the first linear tensile springs 5; the upper ends of the first linear tensile springs 5 are fixed, and the lower ends are connected with the upper ends of the first lightweight high-strength thin strings 6; the first lightweight high-strength thin strings 6 pass vertically downward through the first fixed bearing pulleys 4, the first lightweight high-strength thin strings 6 that are inclined or vertical are tangent to the outer wall surfaces of the rigid arc-shaped supporting arms 3 and are wound in the grooves on the outer wall surfaces, and the lower ends of the first lightweight high-strength thin strings 6 are fixed to the bottom of the rigid arc-shaped supporting arms 3; two second fixed bearing pulleys 7, two second linear tensile springs 8, and two second lightweight high-strength thin strings 9 are provided at each lower side of the rigid model 1 and arranged in a symmetrical structure, and the second fixed bearing pulleys 7 are ensured to be directly above the second linear tensile springs 8; the lower ends of the second linear tensile springs 8 are fixed, the upper ends are connected with the lower ends of the second lightweight high-strength thin strings 9, the second lightweight high-strength thin strings 9 pass vertically upward through the second fixed bearing pulleys 7, the second lightweight high-strength thin strings 9 that are inclined or vertical are tangent to the outer wall surfaces of the rigid arc-shaped supporting arms 3 and are wound in the grooves on the outer wall surfaces, and the upper ends of the second lightweight high-strength thin strings 9 are fixed to the top of the rigid arc-shaped supporting arms 3; this design ensures that during the vertical-torsional coupled free-vibration process of the rigid model 1 and the rigid arc-shaped supporting arms 3, t he first lightweight high-strength thin strings 6 above the first fixed bearing pulleys 4 and the second lightweight high-strength thin strings 9 below the second fixed bearing pulleys 7 remain in a vertical state, so that the first linear tensile springs 5 and the second linear tensile springs 8 only undergo vertical stretching and contracting deformation; and by taking advantage of the nonlinear variation of inclination angles of the first lightweight high-strength thin strings 6 below the first fixed bearing pulleys 4 and/or the second lightweight high-strength thin strings 9 above the second fixed bearing pulleys 7 with the vertical displacement of the rigid model 1, the deformations of the first linear tensile springs 5 and the second linear tensile springs 8 exhibit a nonlinear relationship with the vertical displacement of the rigid model 1.

When the shape of the rigid arc-shaped supporting arm 3 is a variable-radius arc, by taking advantage of the nonlinear variation of tangential distances from the first lightweight high-strength thin strings 6 and the second lightweight high-strength thin strings 9 to the variable-radius rigid arc-shaped supporting arms 3 with the torsional displacement of the rigid model 1, the deformations of the first linear tensile springs 5 and the second linear tensile springs 8 exhibit a nonlinear relationship with the torsional displacement of the rigid model 1; both the vertical displacement and the torsional displacement of the rigid model 1 can change the inclination angles and the tangential distances, thereby achieving the vertical-torsional coupled nonlinear stiffness; and when the shape of the rigid arc-shaped supporting arm 3 is a constant-radius circular arc, the tangential distances from the first lightweight high-strength thin strings 6 and the second lightweight high-strength thin strings 9 to the constant-radius rigid arc-shaped supporting arms 3 are always constant, the deformations of the first linear tensile springs 5 and the second linear tensile springs 8 always have a linear relationship with the torsional displacement of the rigid model 1, thereby achieving nonlinear stiffness only in the vertical direction while maintaining constant torsional stiffness.

The nonlinear stiffness of the free-vibration testing device is related to the following parameters: the vertical displacement and the torsional displacement of the rigid model 1, the original lengths, the initial strains, and the stiffness coefficients of the first linear tensile springs 5 and the second linear tensile springs 8, the shape and the size of the rigid arc-shaped supporting arms 3, the spatial positions of the two first fixed bearing pulleys 4, and the spatial positions of the two second fixed bearing pulleys 7; the shape and the size of the rigid arc-shaped supporting arms 3 and the spatial positions of the first fixed bearing pulleys 4 determine the initial inclination angles of the first lightweight high-strength thin strings 6 and the initial tangential distances between the first lightweight high-strength thin strings 6 and the rigid arc-shaped supporting arms 3; the shape and the size of the rigid arc-shaped supporting arms 3 and the spatial positions of the second fixed bearing pulleys 7 determine the initial inclination angles of the second lightweight high-strength thin strings 9 and the initial tangential distances between the second lightweight high-strength thin strings 9 and the rigid arc-shaped supporting arms 3; and the nonlinear degree of stiffness is improved by increasing the initial inclination angles of the first lightweight high-strength thin strings 6 and the second lightweight high-strength thin strings 9, enhancing the variation degree of the inner radius of the rigid arc-shaped supporting arm 3, and reducing the initial strains of the first linear tensile springs 5 and the second linear tensile springs 8.

The shape and the size of the rigid arc-shaped supporting arms 3 shall be determined according to the target nonlinear stiffness of the free-vibration testing device as well as the vertical amplitude, the torsional amplitude, the mass, the mass moment of inertia, and the torsional-to-vertical frequency ratio of the rigid model 1; when the shape of the rigid arc-shaped supporting arm 3 is a variable-radius arc, the rigid arc-shaped supporting arm 3 is in left-right symmetry about the vertical line at the center, up-down symmetry about the horizontal line at the center, or up-down asymmetry about the horizontal line at the center; for a working condition where the torsional stiffness decreases with the increase of the absolute value of the torsional displacement, the initial tangential distances of the first lightweight high-strength thin strings 6 and the second lightweight high-strength thin strings 9 are as close as possible to the long axes of the rigid arc-shaped supporting arms 3, so that when the rigid model 1 generates torsional displacement, the tangential distances are far from the long axes and decrease, thereby reducing the torsional stiffness; for a working condition where the torsional stiffness increases with the increase of the absolute value of the torsional displacement, the initial tangential distances of the first lightweight high-strength thin strings 6 and the second lightweight high-strength thin strings 9 are as close as possible to the short axes of the rigid arc-shaped supporting arms 3, so that when the rigid model 1 generates torsional displacement, the tangential distances are far from the short axes and increase, thereby increasing the torsional stiffness; and when the shape of the rigid arc-shaped supporting arm 3 is a constant-radius circular arc, under the condition of keeping vertical nonlinear stiffness unchanged, the radius of the arc is increased as much as possible to improve the torsional-to-vertical frequency ratio, avoiding the interference of torsional vibration on vertical vibration that may occur under different working conditions, and ensuring the accuracy of large-amplitude vertical galloping tests.

The first fixed bearing pulleys 4 and the second fixed bearing pulleys 7 are arranged on a rigid frame outside a wind tunnel for suspending the rigid model 1, the spatial positions are adjusted according to the target nonlinear stiffness, and it is necessary to ensure that the first fixed bearing pulleys 4 and the second fixed bearing pulleys 7 do not collide with the rigid arc-shaped supporting arms 3 within the designed amplitude; for a working condition where the vertical stiffness increases with the increase of the vertical downward displacement and decreases with the increase of the vertical upward displacement, the spatial positions of the two first fixed bearing pulleys 4 are adjusted so that the first lightweight high-strength thin strings 6 below the first fixed bearing pulleys 4 generate appropriate initial inclination angles, and the distance between the two second fixed bearing pulleys 7 is adjusted so that the second lightweight high-strength thin strings 9 are entirely in a vertical state; for a working condition where the vertical stiffness decreases with the increase of the vertical downward displacement and increases with the increase of the vertical upward displacement, the distance between the two first fixed bearing pulleys 4 is adjusted so that the first lightweight high-strength thin strings 6 are entirely in a vertical state, and the spatial positions of the two second fixed bearing pulleys 7 are adjusted so that the second lightweight high-strength thin strings 9 above the second fixed bearing pulleys 7 generate appropriate initial inclination angles; and for a working condition where the vertical stiffness increases with the increase of the absolute value of the vertical displacement or decreases with the increase of the absolute value of the vertical displacement, the spatial positions of the two first fixed bearing pulleys 4 and the two second fixed bearing pulleys 7 are adjusted respectively so that the first lightweight high-strength thin strings 6 and the second lightweight high-strength thin strings 9 generate appropriate initial inclination angles. The first lightweight high-strength thin strings 6 and the second lightweight high-strength thin strings 9 are inclined towards the inner side or the outer side of the model according to actual conditions.

The first fixed bearing pulleys 4 and the second fixed bearing pulleys 7 have light weight and high strength, and the rotational friction coefficient of bearings is as small as possible. During the vibration process of the system, the first lightweight high-strength thin strings 6 and the second lightweight high-strength thin strings 9 will be respectively pressed against the first fixed bearing pulleys 4 and the second fixed bearing pulleys 7 and drive the first fixed bearing pulleys 4 and the second fixed bearing pulleys 7 to rotate. The scheme of adopting small-diameter bearings and large-diameter pulleys can reduce the rotational travel of the bearings, decrease the energy consumption of the system, and lower the damping of the vibration system under the condition that the first lightweight high-strength thin strings 6 and/or the second lightweight high-strength thin strings 9 have the same displacement.

The first lightweight high-strength thin strings 6 and the second lightweight high-strength thin strings 9 have the characteristics of light weight, high strength, high elastic modulus, and negligible bending and torsional stiffnesses, with the material not limited. The first lightweight high-strength thin strings 6 and the second lightweight high-strength thin strings 9 shall have sufficient length to ensure that the first linear tensile springs 5 do not collide with the first fixed bearing pulleys 4 and the second linear tensile springs 8 do not collide with the second fixed bearing pulleys 7 within the designed amplitude.

The present invention has the following beneficial effects: (1) this device can achieve vertical-torsional coupled nonlinear stiffness as well as nonlinear stiffness only in the vertical direction while maintaining constant torsional stiffness, so as to carry out large-amplitude vertical-torsional coupled flutter and large-amplitude vertical galloping measurement tests under the nonlinear stiffness of bridge structures; (2) by flexibly designing the shape and the size of the rigid arc-shaped supporting arms, the spatial positions of the fixed bearing pulleys, the initial strains of the springs, and other parameters, this device can achieve multiple complex nonlinear stiffness variation modes with displacement; (3) during the large-amplitude vibration process of the model, the springs can always remain in a vertical state and will not experience lateral vibration, ensuring that the testing device has stable low damping, mass, and stiffness characteristics; and (4) this device is low in cost, easy to process, highly efficient, and feasible.

### DESCRIPTION OF DRAWINGS

FIG. 1 is a symmetric half structural diagram of a free-vibration wind tunnel test device for nonlinear stiffness when the thin strings are inclined outward.

FIG. 2(a)~FIG. 2 (d) shows external structural diagrams of different rigid arc-shaped supporting arms, wherein FIG. 2 (a) is an external structural diagram of an elliptic arc (long axis) supporting arm, FIG. 2 (b) is an external structural diagram of an elliptic arc (short axis) supporting arm, FIG. 2 (c) is an external structural diagram of an involute supporting arm, and FIG. 2 (d) is an external structural diagram of a constant-radius circular arc supporting arm.

FIG. 3 is a symmetric half structural diagram of a free-vibration wind tunnel test device for nonlinear stiffness when the first lightweight high-strength thin strings are inclined.

FIG. 4 is a symmetric half structural diagram of a free-vibration wind tunnel test device for nonlinear stiffness when the second lightweight high-strength thin strings are inclined.

FIG. 5 is a symmetric half structural diagram of a free-vibration wind tunnel test device for nonlinear stiffness when the thin strings are inclined inward.

In the figures: 1 rigid model; 2 rigid rod; 3 rigid arc-shaped supporting arm; 4 first fixed bearing pulley; 5 first linear tensile spring; 6 first lightweight high-strength thin string; 7 second fixed bearing pulley; 8 second linear tensile spring; 9 second lightweight high-strength thin string.

### DETAILED DESCRIPTION

Specific embodiments of the present invention are described below in detail in combination with the technical solution and the drawings.

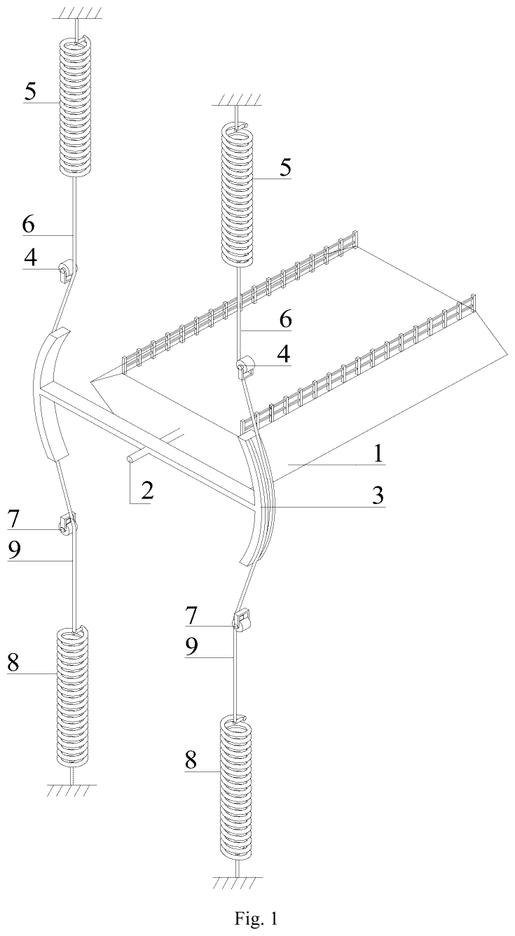

As shown in FIG. 1, a free-vibration testing device for simulating nonlinear stiffness of a bridge rigid model comprises a rigid model 1, rigid rods 2, rigid arc-shaped supporting arms 3, first fixed bearing pulleys 4, first linear tensile springs 5, first lightweight high-strength thin strings 6, second fixed bearing pulleys 7, second linear tensile springs 8, and second lightweight high-strength thin strings 9; the rigid rods 2 are fixed at both ends of the rigid model 1, the torsion center line of the rigid model 1 is ensured to be collinear with the axes of the rigid rods 2, and the free ends of the rigid rods 2 pass perpendicularly through and are fixed to the center of the rigid arc-shaped supporting arms 3; the rigid arc-shaped supporting arm 3 is of a symmetrical structure and is mainly composed of arc-shaped rods connected to both ends of a straight rod, and the outer wall surfaces of the arc-shaped rods are provided with grooves; two first fixed bearing pulleys 4, two first linear tensile springs 5, and two first lightweight high-strength thin strings 6 are provided at each upper side of the rigid model 1 and arranged in a symmetrical structure, and the first fixed bearing pulleys 4 are ensured to be directly below the first linear tensile springs 5; the upper ends of the first linear tensile springs 5 are fixed, and the lower ends are connected with the upper ends of the first lightweight high-strength thin strings 6; the first lightweight high-strength thin strings 6 pass vertically downward through the first fixed bearing pulleys 4, the first lightweight high-strength thin strings 6 that are inclined or vertical are tangent to the outer wall surfaces of the rigid arc-shaped supporting arms 3 and are wound in the grooves on the outer wall surfaces, and the lower ends of the first lightweight high-strength thin strings 6 are fixed to the bottom of the rigid arc-shaped supporting arms 3; two second fixed bearing pulleys 7, two second linear tensile springs 8, and two second lightweight high-strength thin strings 9 are provided at each lower side of the rigid model 1 and arranged in a symmetrical structure, and the second fixed bearing pulleys 7 are ensured to be directly above the second linear tensile springs 8; the lower ends of the second linear tensile springs 8 are fixed, the upper ends are connected with the lower ends of the second lightweight high-strength thin strings 9, the second lightweight high-strength thin strings 9 pass vertically upward through the second fixed bearing pulleys 7, the second lightweight high-strength thin strings 9 that are inclined or vertical are tangent to the outer wall surfaces of the rigid arc-shaped supporting arms 3 and are wound in the grooves on the outer wall surfaces, and the upper ends of the second lightweight high-strength thin strings 9 are fixed to the top of the rigid arc-shaped supporting arms 3; this design ensures that during the vertical-torsional coupled free-vibration process of the rigid model 1 and the rigid arc-shaped supporting arms 3, the first lightweight high-strength thin strings 6 above the first fixed bearing pulleys 4 and the second lightweight high-strength thin strings 9 below the second fixed bearing pulleys 7 remain in a vertical state, so that the first linear tensile springs 5 and the second linear tensile springs 8 only undergo vertical stretching and contracting deformation; and by taking advantage of the nonlinear variation of inclination angles of the first lightweight high-strength thin strings 6 below the first fixed bearing pulleys 4 and/or the second lightweight high-strength thin strings 9 above the second fixed bearing pulleys 7 with the vertical displacement of the rigid model 1, the deformations of the first linear tensile springs 5 and the second linear tensile springs 8 exhibit a nonlinear relationship with the vertical displacement of the rigid model 1.

As shown in FIG. 1, when the shape of the rigid arc-shaped supporting arm 3 is a variable-radius arc, by taking advantage of the nonlinear variation of tangential distances from the first lightweight high-strength thin strings 6 and the second lightweight high-strength thin strings 9 to the variable-radius rigid arc-shaped supporting arms 3 with the torsional displacement of the rigid model 1, the deformations of the first linear tensile springs 5 and the second linear tensile springs 8 exhibit a nonlinear relationship with the torsional displacement of the rigid model 1; both the vertical displacement and the torsional displacement of the rigid model 1 can change the inclination angles and the tangential distances, thereby achieving the vertical-torsional coupled nonlinear stiffness; and when the shape of the rigid arc-shaped supporting arm 3 is a constant-radius circular arc, the tangential distances from the first lightweight high-strength thin strings 6 and the second lightweight high-strength thin strings 9 to the constant-radius rigid arc-shaped supporting arms 3 are always constant, the deformations of the first linear tensile springs 5 and the second linear tensile springs 8 always have a linear relationship with the torsional displacement of the rigid model 1, thereby achieving nonlinear stiffness only in the vertical direction while maintaining constant torsional stiffness.

The nonlinear stiffness of the free-vibration testing device is related to the following parameters: the vertical displacement and the torsional displacement of the rigid model 1, the original lengths, the initial strains, and the stiffness coefficients of the first linear tensile springs 5 and the second linear tensile springs 8, the shape and the size of the rigid arc-shaped supporting arms 3, the spatial positions of the two first fixed bearing pulleys 4, and the spatial positions of the two second fixed bearing pulleys 7; the shape and the size of the rigid arc-shaped supporting arms 3 and the spatial positions of the first fixed bearing pulleys 4 determine the initial inclination angles of the first lightweight high-strength thin strings 6 and the initial tangential distances between the first lightweight high-strength thin strings 6 and the rigid arc-shaped supporting arms 3; the shape and the size of the rigid arc-shaped supporting arms 3 and the spatial positions of the second fixed bearing pulleys 7 determine the initial inclination angles of the second lightweight high-strength thin strings 9 and the initial tangential distances between the second lightweight high-strength thin strings 9 and the rigid arc-shaped supporting arms 3; and the nonlinear degree of stiffness is improved by increasing the initial inclination angles of the first lightweight high-strength thin strings 6 and the second lightweight high-strength thin strings 9, enhancing the variation degree of the inner radius of the rigid arc-shaped supporting arm 3, and reducing the initial strains of the first linear tensile springs 5 and the second linear tensile springs 8.

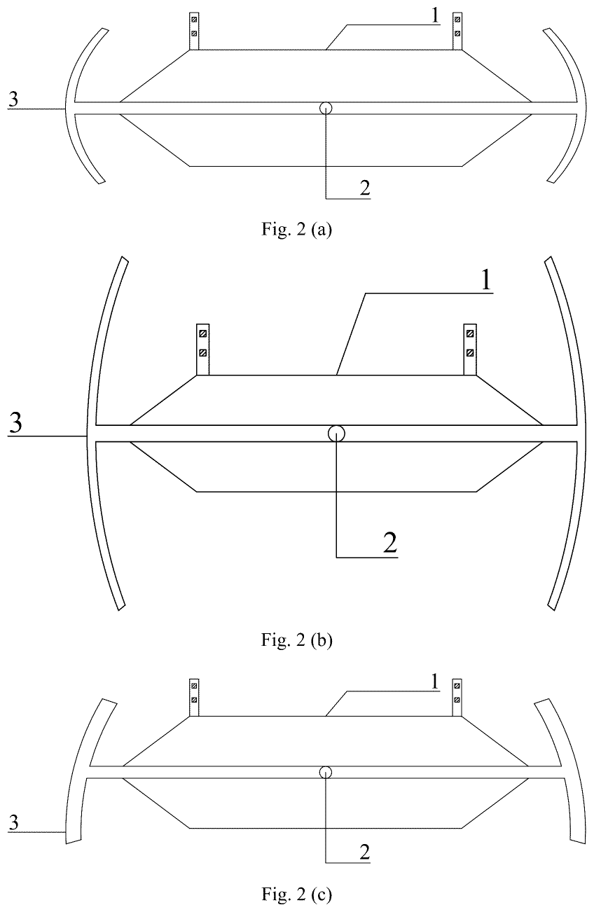

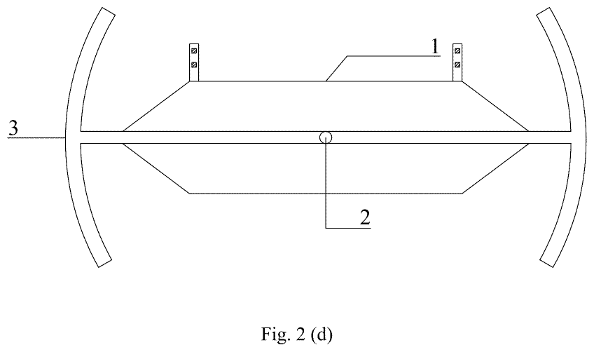

As shown in FIG. 2 (a)~FIG. 2 (d), the shape and the size of the rigid arc-shaped supporting arms 3 shall be determined according to the target nonlinear stiffness of the free-vibration testing device as well as the vertical amplitude, the torsional amplitude, the mass, the mass moment of inertia, and the torsional-to-vertical frequency ratio of the rigid model 1; when the shape of the rigid arc-shaped supporting arm 3 is a variable-radius arc, the rigid arc-shaped supporting arm 3 is in left-right symmetry about the vertical line at the center, up-down symmetry about the horizontal line at the center, or up-down asymmetry about the horizontal line at the center; for a working condition where the torsional stiffness decreases with the increase of the absolute value of the torsional displacement, the initial tangential distances of the first lightweight high-strength thin strings 6 and the second lightweight high-strength thin strings 9 are as close as possible to the long axes of the rigid arc-shaped supporting arms 3, so that when the rigid model 1 generates torsional displacement, the tangential distances are far from the long axes and decrease, thereby reducing the torsional stiffness; for a working condition where the torsional stiffness increases with the increase of the absolute value of the torsional displacement, the initial tangential distances of the first lightweight high-strength thin strings 6 and the second lightweight high-strength thin strings 9 are as close as possible to the short axes of the rigid arc-shaped supporting arms 3, so that when the rigid model 1 generates torsional displacement, the tangential distances are far from the short axes and increase, thereby increasing the torsional stiffness; and when the shape of the rigid arc-shaped supporting arm 3 is a constant-radius circular arc, under the condition of keeping vertical nonlinear stiffness unchanged, the radius of the arc is increased as much as possible to improve the torsional-to-vertical frequency ratio, avoiding the interference of torsional vibration on vertical vibration that may occur under different working conditions, and ensuring the accuracy of large-amplitude vertical galloping tests.

The first fixed bearing pulleys 4 and the second fixed bearing pulleys 7 are arranged on a rigid frame outside a wind tunnel for suspending the rigid model 1, the spatial positions are adjusted according to the target nonlinear stiffness, and it is necessary to ensure that the first fixed bearing pulleys 4 and the second fixed bearing pulleys 7 do not collide with the rigid arc-shaped supporting arms 3 within the designed amplitude.

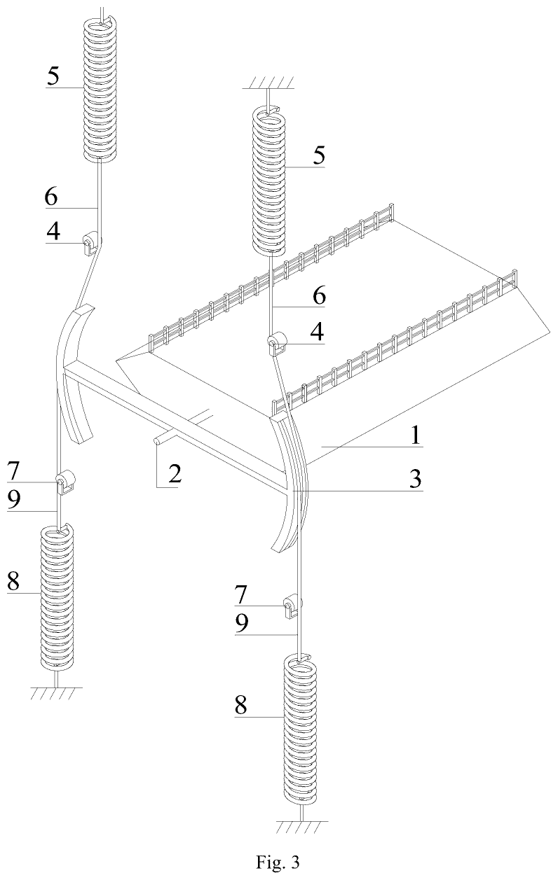

As shown in FIG. 3, for a working condition where the vertical stiffness increases with the increase of the vertical downward displacement and decreases with the increase of the vertical upward displacement, the spatial positions of the two first fixed bearing pulleys 4 are adjusted so that the first lightweight high-strength thin strings 6 below the first fixed bearing pulleys 4 generate appropriate initial inclination angles, and the distance between the two second fixed bearing pulleys 7 is adjusted so that the second lightweight high-strength thin strings 9 are entirely in a vertical state.

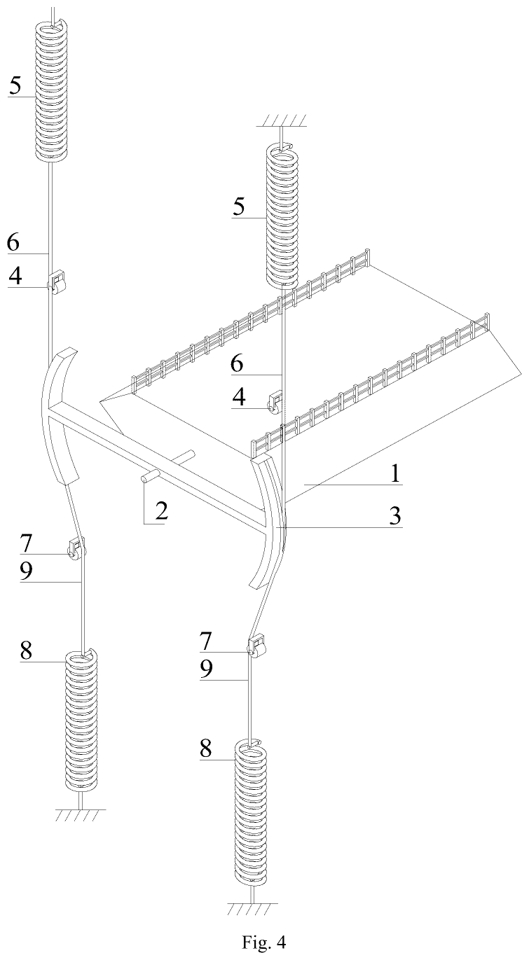

As shown in FIG. 4, for a working condition where the vertical stiffness decreases with the increase of the vertical downward displacement and increases with the increase of the vertical upward displacement, the distance between the two first fixed bearing pulleys 4 is adjusted so that the first lightweight high-strength thin strings 6 are entirely in a vertical state, and the spatial positions of the two second fixed bearing pulleys 7 are adjusted so that the second lightweight high-strength thin strings 9 above the second fixed bearing pulleys 7 generate appropriate initial inclination angles.

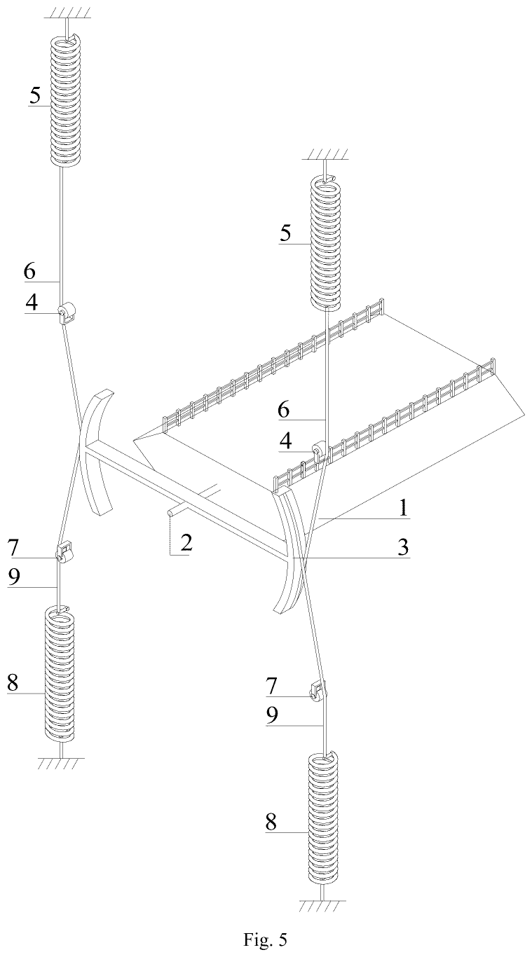

As shown in FIG. 1 and FIG. 5, for a working condition where the vertical stiffness increases with the increase of the absolute value of the vertical displacement or decreases with the increase of the absolute value of the vertical displacement, the spatial positions of the two first fixed bearing pulleys 4 and the two second fixed bearing pulleys 7 are adjusted respectively so that the first lightweight high-strength thin strings 6 and the second lightweight high-strength thin strings 9 generate appropriate initial inclination angles. The first lightweight high-strength thin strings 6 and the second lightweight high-strength thin strings 9 are inclined towards the inner side or the outer side of the model according to actual conditions.

The first fixed bearing pulleys 4 and the second fixed bearing pulleys 7 have light weight and high strength, and the rotational friction coefficient of bearings is as small as possible. The scheme of adopting small-diameter bearings and large-diameter pulleys can reduce the rotational travel of the bearings, decrease the energy consumption of the system, and lower the damping of the vibration system under the condition that the first lightweight high-strength thin strings 6 and/or the second lightweight high-strength thin strings 9 have the same displacement.

The first lightweight high-strength thin strings 6 and the second lightweight high-strength thin strings 9 have the characteristics of light weight, high strength, high elastic modulus, and negligible bending and torsional stiffnesses, with the material not limited. The first lightweight high-strength thin strings 6 and the second lightweight high-strength thin strings 9 shall have sufficient length to ensure that the first linear tensile springs 5 do not collide with the first fixed bearing pulleys 4 and the second linear tensile springs 8 do not collide with the second fixed bearing pulleys 7 within the designed amplitude.

The above only describes preferred embodiments of the present invention and is not intended to limit the present invention in any form. Any equivalent change, modification or evolution made to the above embodiments by those skilled in the art through the technical solution of the present invention shall still belong to the scope of the technical solution of the present invention.

1. A free-vibration testing device for simulating nonlinear stiffness of a bridge rigid model, wherein the free-vibration testing device comprises a rigid model (1), rigid rods (2), rigid arc-shaped supporting arms (3), first fixed bearing pulleys (4), first linear tensile springs (5), first lightweight high-strength thin strings (6), second fixed bearing pulleys (7), second linear tensile springs (8), and second lightweight high-strength thin strings (9);
the rigid rods (2) are fixed at both ends of the rigid model (1), the torsion center line of the rigid model (1) is ensured to be collinear with the axes of the rigid rods (2), and the free ends of the rigid rods (2) pass perpendicularly through and are fixed to the center of the rigid arc-shaped supporting arms (3); the rigid arc-shaped supporting arm (3) is of a symmetrical structure and is mainly composed of arc-shaped rods connected to both ends of a straight rod, and the outer wall surfaces of the arc-shaped rods are provided with grooves; two first fixed bearing pulleys (4), two first linear tensile springs (5), and two first lightweight high-strength thin strings (6) are provided at each upper side of the rigid model (1) and arranged in a symmetrical structure, and the first fixed bearing pulleys (4) are ensured to be directly below the first linear tensile springs (5); the upper ends of the first linear tensile springs (5) are fixed, and the lower ends are connected with the upper ends of the first lightweight high-strength thin strings (6); the first lightweight high-strength thin strings (6) pass vertically downward through the first fixed bearing pulleys (4), the first lightweight high-strength thin strings (6) that are inclined or vertical are tangent to the outer wall surfaces of the rigid arc-shaped supporting arms (3) and are wound in the grooves on the outer wall surfaces, and the lower ends of the first lightweight high-strength thin strings (6) are fixed to the bottom of the rigid arc-shaped supporting arms (3); two second fixed bearing pulleys (7), two second linear tensile springs (8), and two second lightweight high-strength thin strings (9) are provided at each lower side of the rigid model (1) and arranged in a symmetrical structure, and the second fixed bearing pulleys (7) are ensured to be directly above the second linear tensile springs (8); the lower ends of the second linear tensile springs (8) are fixed, the upper ends are connected with the lower ends of the second lightweight high-strength thin strings (9), the second lightweight high-strength thin strings (9) pass vertically upward through the second fixed bearing pulleys (7), the second lightweight high-strength thin strings (9) that are inclined or vertical are tangent to the outer wall surfaces of the rigid arc-shaped supporting arms (3) and are wound in the grooves on the outer wall surfaces, and the upper ends of the second lightweight high-strength thin strings (9) are fixed to the top of the rigid arc-shaped supporting arms (3); this design ensures that during the vertical-torsional coupled free-vibration process of the rigid model (1) and the rigid arc-shaped supporting arms (3), the first lightweight high-strength thin strings (6) above the first fixed bearing pulleys (4) and the second lightweight high-strength thin strings (9) below the second fixed bearing pulleys (7) remain in a vertical state, so that the first linear tensile springs (5) and the second linear tensile springs (8) only undergo vertical stretching and contracting deformation; and by taking advantage of the nonlinear variation of inclination angles of the first lightweight high-strength thin strings (6) below the first fixed bearing pulleys (4) and/or the second lightweight high-strength thin strings (9) above the second fixed bearing pulleys (7) with the vertical displacement of the rigid model (1), the deformations of the first linear tensile springs (5) and the second linear tensile springs (8) exhibit a nonlinear relationship with the vertical displacement of the rigid model (1);
when the shape of the rigid arc-shaped supporting arm (3) is a variable-radius arc, by taking advantage of the nonlinear variation of tangential distances from the first lightweight high-strength thin strings (6) and the second lightweight high-strength thin strings (9) to the variable-radius rigid arc-shaped supporting arms (3) with the torsional displacement of the rigid model (1), the deformations of the first linear tensile springs (5) and the second linear tensile springs (8) exhibit a nonlinear relationship with the torsional displacement of the rigid model (1); both the vertical displacement and the torsional displacement of the rigid model (1) can change the inclination angles and the tangential distances, thereby achieving the vertical-torsional coupled nonlinear stiffness; and when the shape of the rigid arc-shaped supporting arm (3) is a constant-radius circular arc, the tangential distances from the first lightweight high-strength thin strings (6) and the second lightweight high-strength thin strings (9) to the constant-radius rigid arc-shaped supporting arms (3) are always constant, the deformations of the first linear tensile springs (5) and the second linear tensile springs (8) always have a linear relationship with the torsional displacement of the rigid model (1), thereby achieving nonlinear stiffness only in the vertical direction while maintaining constant torsional stiffness.

2. The free-vibration testing device according to claim 1, wherein the nonlinear stiffness of the free-vibration testing device is related to the following parameters:
the vertical displacement and the torsional displacement of the rigid model (1), the original lengths, the initial strains, and the stiffness coefficients of the first linear tensile springs (5) and the second linear tensile springs (8), the shape and the size of the rigid arc-shaped supporting arms (3), the spatial positions of the two first fixed bearing pulleys (4), and the spatial positions of the two second fixed bearing pulleys (7); the shape and the size of the rigid arc-shaped supporting arms (3) and the spatial positions of the first fixed bearing pulleys (4) determine the initial inclination angles of the first lightweight high-strength thin strings (6) and the initial tangential distances between the first lightweight high-strength thin strings (6) and the rigid arc-shaped supporting arms (3); the shape and the size of the rigid arc-shaped supporting arms (3) and the spatial positions of the second fixed bearing pulleys (7) determine the initial inclination angles of the second lightweight high-strength thin strings (9) and the initial tangential distances between the second lightweight high-strength thin strings (9) and the rigid arc-shaped supporting arms (3); and the nonlinear degree of stiffness is improved by increasing the initial inclination angles of the first lightweight high-strength thin strings (6) and the second lightweight high-strength thin strings (9), enhancing the variation degree of the inner radius of the rigid arc-shaped supporting arm (3), and reducing the initial strains of the first linear tensile springs (5) and the second linear tensile springs (8).

3. The free-vibration testing device according to claim 2, wherein the shape and the size of the rigid arc-shaped supporting arms (3) are determined according to the target nonlinear stiffness of the free-vibration testing device as well as the vertical amplitude, the torsional amplitude, the mass, the mass moment of inertia, and the torsional-to-vertical frequency ratio of the rigid model (1); when the shape of the rigid arc-shaped supporting arm (3) is a variable-radius arc, the rigid arc-shaped supporting arm (3) is in left-right symmetry about the vertical line at the center, up-down symmetry about the horizontal line at the center, or up-down asymmetry about the horizontal line at the center; for a working condition where the torsional stiffness decreases with the increase of the absolute value of the torsional displacement, the initial tangential distances of the first lightweight high-strength thin strings (6) and the second lightweight high-strength thin strings (9) are as close as possible to the long axes of the rigid arc-shaped supporting arms (3), so that when the rigid model (1) generates torsional displacement, the tangential distances are far from the long axes and decrease, thereby reducing the torsional stiffness; for a working condition where the torsional stiffness increases with the increase of the absolute value of the torsional displacement, the initial tangential distances of the first lightweight high-strength thin strings (6) and the second lightweight high-strength thin strings (9) are as close as possible to the short axes of the rigid arc-shaped supporting arms (3), so that when the rigid model (1) generates torsional displacement, the tangential distances are far from the short axes and increase, thereby increasing the torsional stiffness; and when the shape of the rigid arc-shaped supporting arm (3) is a constant-radius circular arc, under the condition of keeping vertical nonlinear stiffness unchanged, the radius of the arc is increased as much as possible to improve the torsional-to-vertical frequency ratio, avoiding the interference of torsional vibration on vertical vibration that may occur under different working conditions, and ensuring the accuracy of large-amplitude vertical galloping tests.

4. The free-vibration testing device according to claim 3, wherein the first fixed bearing pulleys (4) and the second fixed bearing pulleys (7) are arranged on a rigid frame outside a wind tunnel for suspending the rigid model (1), the spatial positions are adjusted according to the target nonlinear stiffness, and it is necessary to ensure that the first fixed bearing pulleys (4) and the second fixed bearing pulleys (7) do not collide with the rigid arc-shaped supporting arms (3) within the designed amplitude; for a working condition where the vertical stiffness increases with the increase of the vertical downward displacement and decreases with the increase of the vertical upward displacement, the spatial positions of the two first fixed bearing pulleys (4) are adjusted so that the first lightweight high-strength thin strings (6) below the first fixed bearing pulleys (4) generate initial inclination angles, and the distance between the two second fixed bearing pulleys (7) is adjusted so that the second lightweight high-strength thin strings (9) are entirely in a vertical state; for a working condition where the vertical stiffness decreases with the increase of the vertical downward displacement and increases with the increase of the vertical upward displacement, the distance between the two first fixed bearing pulleys (4) is adjusted so that the first lightweight high-strength thin strings (6) are entirely in a vertical state, and the spatial positions of the two second fixed bearing pulleys (7) are adjusted so that the second lightweight high-strength thin strings (9) above the second fixed bearing pulleys (7) generate initial inclination angles; and for a working condition where the vertical stiffness increases with the increase of the absolute value of the vertical displacement or decreases with the increase of the absolute value of the vertical displacement, the spatial positions of the two first fixed bearing pulleys (4) and the two second fixed bearing pulleys (7) are adjusted respectively so that the first lightweight high-strength thin strings (6) and the second lightweight high-strength thin strings (9) generate initial inclination angles.

5. The free-vibration testing device according to claim 4, wherein the first lightweight high-strength thin strings (6) and the second lightweight high-strength thin strings (9) are inclined towards the inner side or the outer side of the model according to actual conditions.
